(19) United States
(12) Patent Application Publication
(10) Pub. No.: US 2014/0069592 A1
(43) Pub. Date: Mar. 13, 2014

(54) CONTROL ASSEMBLY FOR CORDLESS WINDOW CURTAINS

(71) Applicant: Chun-Jan Hsu, Taichung City (TW)

(72) Inventor: Chun-Jan Hsu, Taichung City (TW)

(21) Appl. No.: 13/725,981

(22) Filed: Dec. 21, 2012

(30) Foreign Application Priority Data
Sep. 11, 2012 (TW) 101217487

(51) Int. Cl. E06B 9/38; E06B 9/24; E06B 9/26

(52) U.S. Cl. CPC E06B 9/38; E06B 9/26; E06B 9/24
USPC 160/84.05; 160/368.1; 160/188; 74/471 R

(57) ABSTRACT

A cordless window curtain includes a curtain connected between the head box and the bottom bar. A controller, a fixed unit and a movably unit are located in the head box. The movable unit is movably located between the controller and the fixed unit. Multiple driving ropes go around guide members of the movable unit and the fixed unit. The resilient rope goes over the pulley in the controller and two ends of the resilient rope are respectively connected to the controller and the fixed unit. By lifting or lowering the bottom bar, the resilient rope is activated to move the movable unit so as to pull or release the driving ropes to allow the curtain to be lifted or lowered.

### FIELD OF THE INVENTION

The present invention relates to a cordless window curtain, and more particularly, to a control assembly for a cordless window curtain.

### BACKGROUND OF THE INVENTION

The conventional window curtain generally comprises a curtain, a control assembly and an operation cord, wherein the control assembly is located in the head box and connected to the operation cord. When the users pull the operation cord, the curtain is lifted or lowered by the operation of the control assembly which is activated by the operation cord. However, the operation cord has to be pulled by a certain force so as to activate the control assembly to lift or lower the curtain. Usually, the curtain is difficult to be positioned at the desired position, so that the user has to pull and loose the operation cord many times. Besides, the control assembly is complicated and the operation cord make the cost of the window curtain be high which means less competitive ability in the market.

The present invention intends to provide a control assembly which is operated by resilient ropes and no operation cord is needed.

### SUMMARY OF THE INVENTION

The present invention relates to a control assembly of a cordless window curtain and comprises a controller having a pulley connected thereto and a resilient rope goes over the pulley. The resilient rope has a first end and a second end. A fixed unit has a first passage defined therethrough and at least two first guide members, at least one first rod and multiple columns are located in the first passage. The second end of the resilient rope is fixed to the at least one first rod. A movable unit is located between the controller and the fixed unit. The movable unit has a second passage defined therethrough. At least two second guide members and multiple second rods are located in the second passage. Multiple rollers are connected to two sides of the movable unit. The first end of the resilient rope is fixed to one of the second rod. A driving rope goes around the at least two first guide members in the fixed unit and the at least two second guide members of the movable unit.

Preferably, the axis of the pulley is perpendicular to the curtain of the cordless window curtain.

Alternatively, the present invention provides a cordless window curtain and comprises a head box and a bottom bar, and a curtain is connected between the head box and the bottom bar. The head box has a space defined therein and multiple holes are defined through the bottom board of the head box. A controller has a pulley connected thereto and a resilient rope goes over the pulley. The resilient rope has a first end and a second end. The controller is located in the space and securely connected to the first end of the head box. A fixed unit has a first passage defined therethrough and at least two first guide members, at least one first rod and multiple columns are located in the first passage. The fixed unit is located in the space and securely connected to the second end of the head box. The second end of the resilient rope is fixed to the at least one first rod. A movable unit is located between the controller and the fixed unit. The movable unit has a second passage defined therethrough. At least two second guide members and multiple second rods are located in the second passage. Multiple rollers are connected to two sides of the movable unit. The movable unit is movably located in the space and the rollers roll along insides of the head box. The first end of the resilient rope is fixed to one of the second rod. A driving rope goes around the at least two first guide members in the fixed unit and the at least two second guide members of the movable unit. One end of the driving rope goes through the hole of the head box and the curtain and is fixed to the bottom bar.

Preferably, the curtain comprises multiple slats or multiple honey-comb units which are connected to each other.

Preferably, the axis of the pulley is perpendicular to the curtain.

The primary object of the present invention is to provide a cordless window curtain that has simple structure and is easily operated.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the control assembly of the cordless window curtain of the present invention;

FIG. 2 is a bottom cross sectional view of the control assembly of the cordless window curtain of the present invention;

FIG. 3 is a top cross sectional view of the control assembly of the cordless window curtain of the present invention;

FIG. 4 shows that the curtain of the cordless window curtain of the present invention is lowered, and

FIG. 5 shows that the curtain of the cordless window curtain of the present invention is lifted.

### DETAILED DESCRIPTION OF THE PREFERRED EMBODIMENT

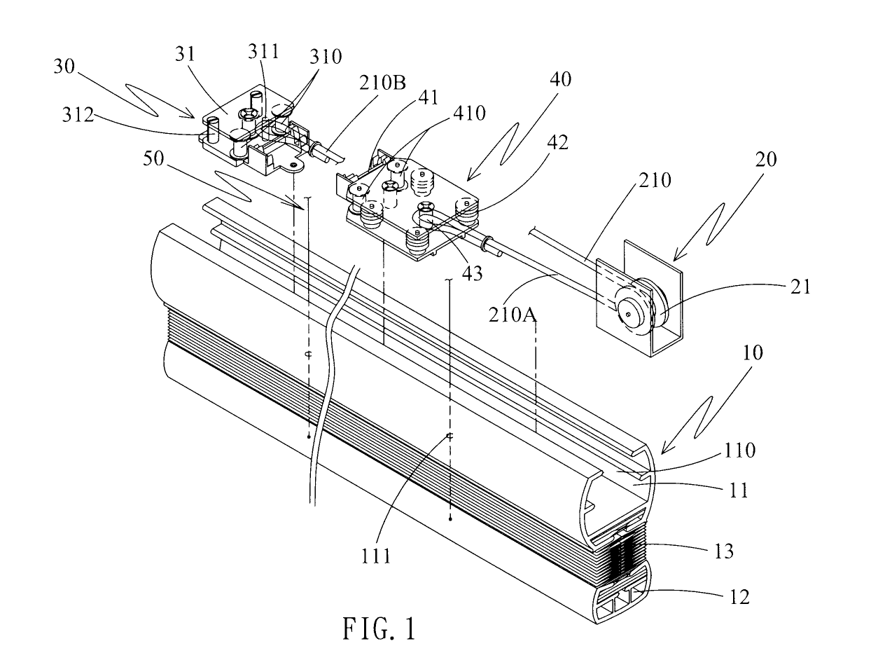

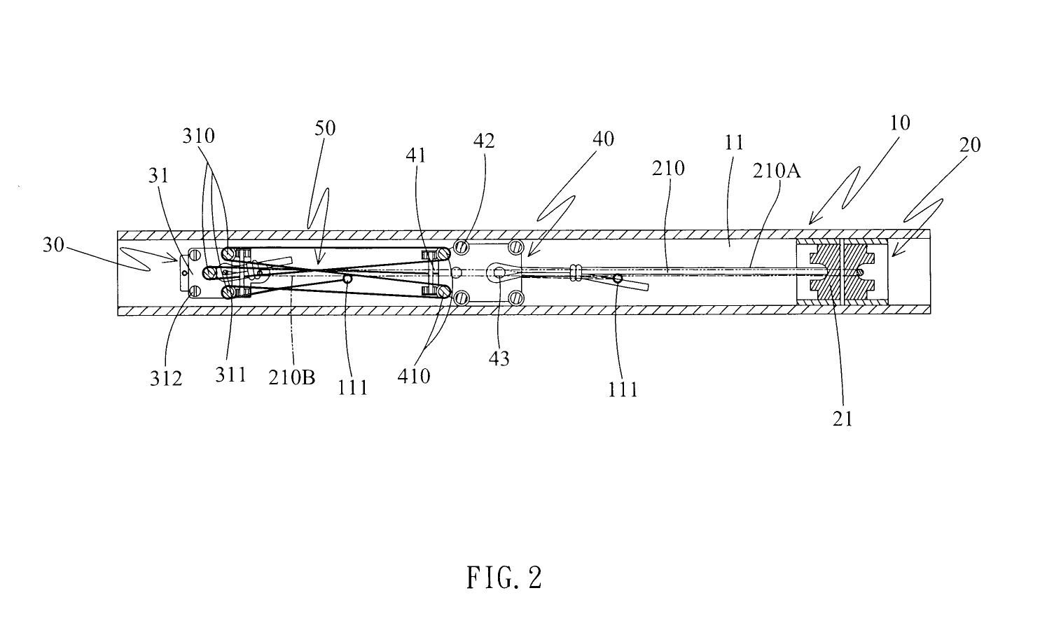

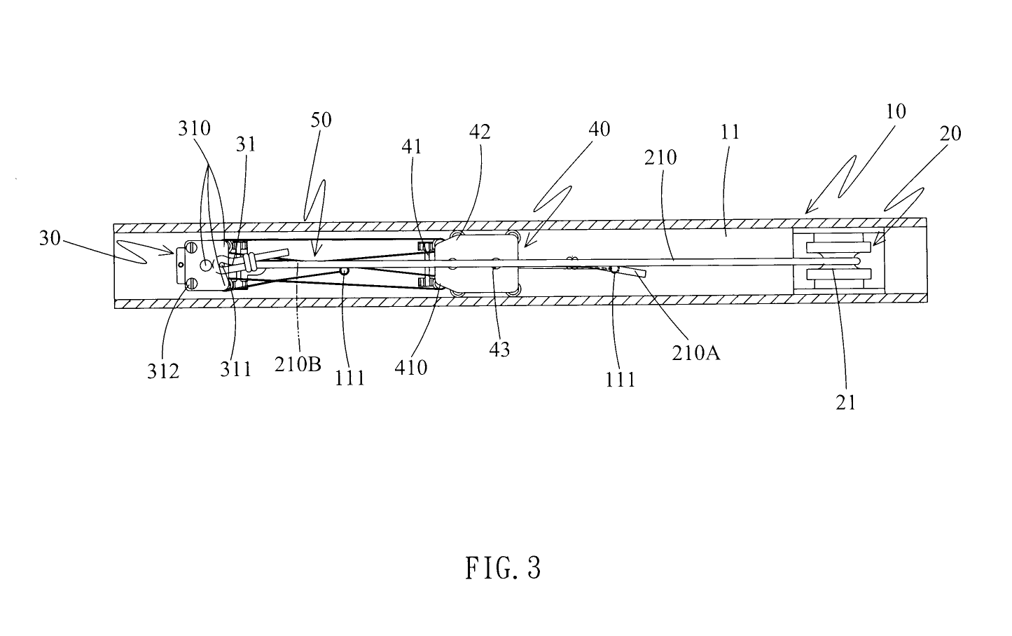

Referring to FIGS. 1 to 3, the cordless window curtain 10 of the present invention comprises a head box 11 and a bottom bar 12, and a curtain 13 is connected between the head box 11 and the bottom bar 12. The head box 11 has a space 110 defined therein and multiple holes 111 are defined through the bottom board of the head box 11. The curtain 13 comprises multiple slats or honey-comb units which are connected to each other. The axis of the pulley 21 is perpendicular to the curtain 13.

A controller 20 is located in the space 110 and securely connected to the first end of the head box 11. The controller 20 has a pulley 21 connected thereto and a resilient rope 210 goes over the pulley 21. The resilient rope 210 has a first end 210A and a second end 210B.

A fixed unit 30 is located in the space 110 and securely connected to the second end of the head box 11. The fixed unit 30 has a first passage 31 defined therethrough and at least two first guide members 310, at least one first rod 311 and multiple columns 312 are located in the first passage 31. The second end 210B of the resilient rope 210 is fixed to the at least one first rod 311.

A movable unit 40 is located in the space 110 and between the controller 2 and the fixed unit, 30. The movable unit 40 has a second passage 41 defined therethrough. At least two second guide members 410 and multiple second rods 43 are located in the second passage 41. Multiple rollers 42 are connected to two sides of the movable unit 40. The movable unit 40 is movable between the controller 2 and the fixed unit, 30. The rollers 42 roll along two flanges on two insides of the head box 11 so that the movable unit 40 can be moved smoothly with less resistance. The first end 210A of the resilient rope 210 is fixed to one of the second rod 43.

Two driving ropes 50 go around the at least two first guide members 310 in the fixed unit 30 and the at least two second guide members 410 of the movable unit 40. Two respective ends of the driving ropes 50 go through the holes 111 of the head box 11 and the curtain 10, and are fixed to the bottom bar 12.

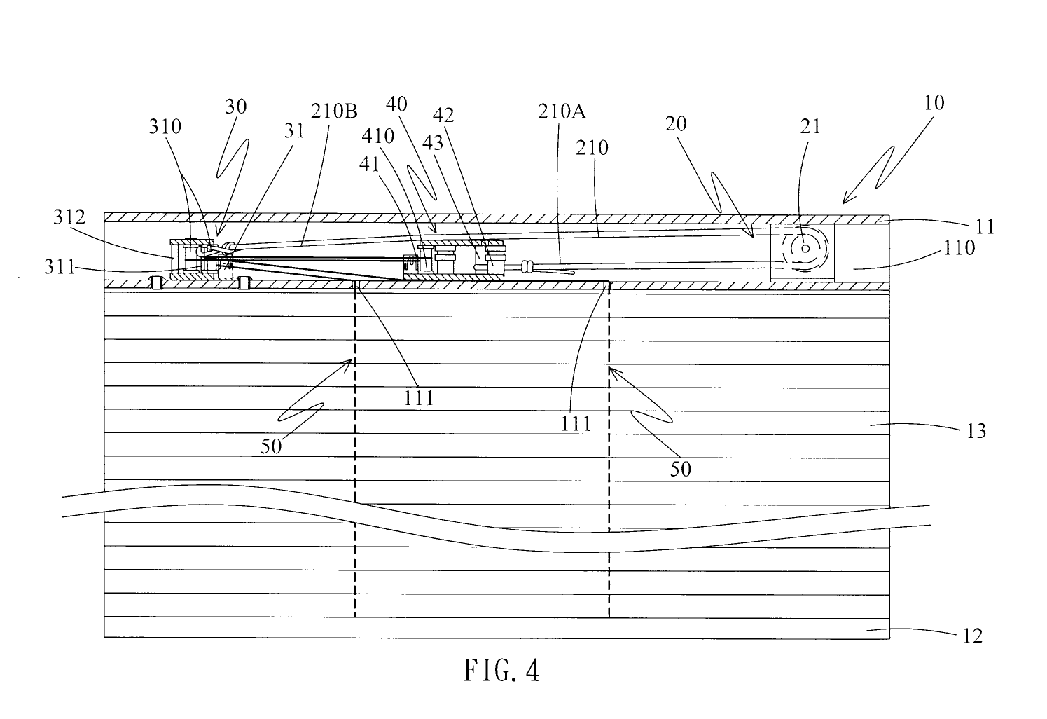

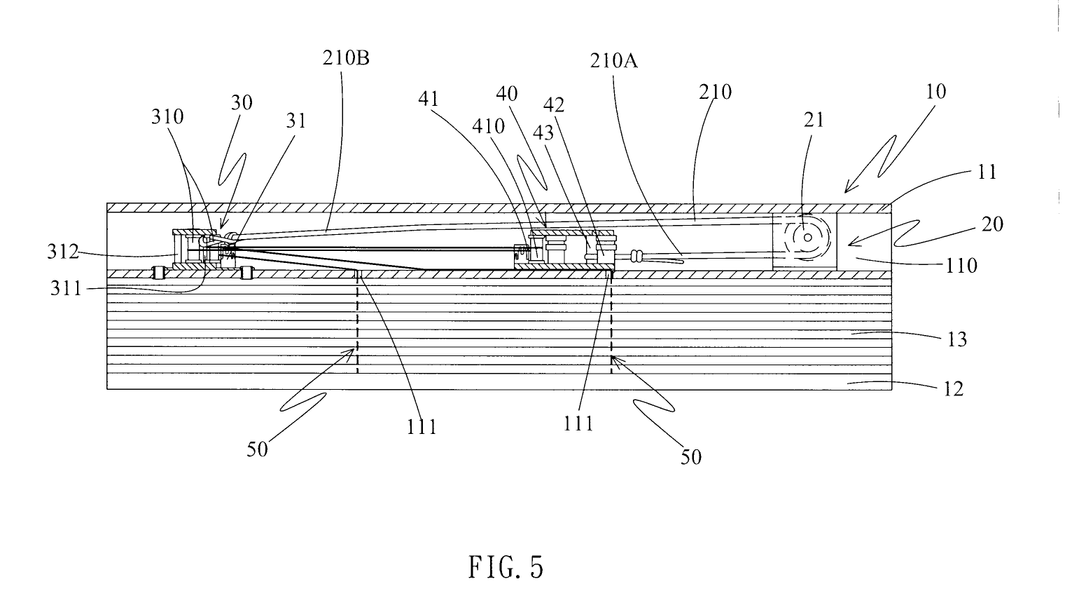

Referring to FIGS. 4 and 5, the controller 20 and the fixed unit 30 are located in the space 110 and respectively and securely connected to the first and second ends of the head box 11. The movable unit 40 is movably located between the controller 20 and the fixed unit 30. The resilient rope 210 goes over the pulley 21 of the controller 20 and the second end 210B of the resilient rope 210 is fixed to the at least one first rod 311, and the first end 210A of the resilient rope 210 is fixed to one of the second rod 43. The rollers 42 of the movable unit 40 roll along the two flanges on the two insides of the head box 11 so that the movable unit 40 can be moved smoothly with less resistance.

The two driving ropes 50 go around the at least two first guide members 310 in the fixed unit 30 and the at least two second guide members 410 of the movable unit 40. Two respective ends of the driving ropes 50 go through the holes 111 of the head box 11 and the curtain 10, and are fixed to the bottom bar 12.

By pulling the bottom bar 12, the resilient rope 210 is stretched and the movable unit 40 moves toward the fixed unit 30. The driving ropes 50 are pulled along with the curtain 13. The curtain 13 is expanded and lowered. On the contrary, when lifting the bottom bar 12, the resilient rope 210 is re-scrolled and the movable unit 40 moves away from the fixed unit 30. The driving ropes 50 are lifted along with the curtain 13. The curtain 13 is lifted.

The structure of the cordless window curtain 10 is simple, the assembling of the control assembly is easy. The axis of the pulley 21 is perpendicular to the curtain 13 so that when maintaining the control assembly, the resilient rope 210 is easily accessed from the open top of the head box 11.

While we have shown and described the embodiment in accordance with the present invention, it should be clear to those skilled in the art that further embodiments may be made without departing from the scope of the present invention.

What is claimed is:

1. A control assembly of a cordless window curtain comprising:
a controller having a pulley connected thereto and a resilient rope going over the pulley, the resilient rope having a first end and a second end;
a fixed unit having a first passage defined therethrough and at least two first guide members, at least one first rod and multiple columns located in the first passage, the second end of the resilient rope fixed to the at least one first rod;
a movable unit located between the controller and the fixed unit, the movable unit having a second passage defined therethrough, at least two second guide members and multiple second rods located in the second passage, multiple rollers connected to two sides of the movable unit, the first end of the resilient rope fixed to one of the second rod, and
a driving rope going around the at least two first guide members in the fixed unit and the at least two second guide members of the movable unit.

2. The cordless window curtain as claimed in claim 1, wherein an axis of the pulley is adapted to be perpendicular to the cordless window curtain.

3. A cordless window curtain comprising:
a head box and a bottom bar, a curtain connected between the head box and the bottom bar, the head box having a space defined therein and multiple holes defined through a bottom board of the head box;
a controller having a pulley connected thereto and a resilient rope going over the pulley, the resilient rope having a first end and a second end, the controller located in the space and securely connected to a first end of the head box;
a fixed unit having a first passage defined therethrough and at least two first guide members, at least one first rod and multiple columns located in the first passage, the fixed unit located in the space and securely connected to a second end of the head box, the second end of the resilient rope fixed to the at least one first rod;
a movable unit located between the controller and the fixed unit, the movable unit having a second passage defined therethrough, at least two second guide members and multiple second rods located in the second passage, multiple rollers connected to two sides of the movable unit, the movable unit movably located in the space and the rollers rolling along insides of the head box, the first end of the resilient rope fixed to one of the second rod, and
a driving rope going around the at least two first guide members in the fixed unit and the at least two second guide members of the movable unit, an end of the driving rope going through the hole of the head box and the curtain and fixed to the bottom bar.

4. The cordless window curtain as claimed in claim 3, wherein the curtain comprises multiple slats.

5. The cordless window curtain as claimed in claim 3, wherein the curtain comprises multiple honey-comb units which are connected to each other.

6. The cordless window curtain as claimed in claim 3, wherein an axis of the pulley is perpendicular to the curtain.
